(19) United States
(12) Patent Application Publication
(10) Pub. No.: US 2014/0099185 A1
(43) Pub. Date: Apr. 10, 2014

(54) HYDROELECTRIC POWER GENERATING DEVICE AND SYSTEM

(71) Applicant: Tom C. Tankersley, Marble Falls, TX (US)

(72) Inventor: Tom C. Tankersley, Marble Falls, TX (US)

(21) Appl. No.: 14/044,876

(22) Filed: Oct. 3, 2013

Related U.S. Application Data
(60) Provisional application No. 61/711,374, filed on Oct. 9, 2012.

(51) Int. Cl. F01D 5/02; F03B 17/06

(52) U.S. Cl. CPC F01D 5/022; F03B 17/061
USPC 415/1; 415/220; 415/199.4; 29/889.2

(57) ABSTRACT

A fluid conduit has a constant diameter and a chamber in the conduit has a larger diameter than the diameter of the conduit. Within the chamber, an impeller is rotatable by fluid moving through the conduit and the chamber. The impeller includes blades extending spirally along an impeller shaft. When rotated, the impeller blades define a cylinder having a diameter greater than the conduit diameter and less than the chamber diameter.

### CROSS REFERENCE TO RELATED APPLICATIONS

The present application is related to and claims priority to Provisional U.S. Application No. 61/711,374 filed on Oct. 9, 2012.

### BACKGROUND

The disclosure relates to an impeller device and system within a fluid conduit and more particularly to an impeller rotated by fluid flowing through the conduit sufficient to generate electrical power.

Attempts have been made to generate electrical energy from fluid flow systems. It is important in such systems that the fluid flow in the conduit not be exposed to significant disruption, which may precipitate effects on other components within the fluid flow system such as pumps used to move the fluid through the conduit. It would be of benefit to provide an electrical power generating system within a fluid conduit capable of substantially maintaining a constant velocity and pressure in the conduit.

### SUMMARY

A fluid conduit has a constant diameter and a chamber in the conduit has a larger diameter than the diameter of the conduit. Within the chamber, an impeller is rotatable by fluid moving through the conduit. The impeller includes blades extending spirally along an impeller shaft. When rotated, the impeller blades define a cylinder having a diameter greater than the conduit diameter and less than the chamber diameter.

### BRIEF DESCRIPTION OF THE DRAWINGS

FIG. 1 is a diagrammatic illustration of an embodiment of a fluid conduit system.

FIGS. 2-5 are isometric views illustrating various embodiments of impellers.

### DETAILED DESCRIPTION

This disclosure describes a new, innovative device and system for generating electricity for industrial, municipal, and commercial facilities. The device involves an impeller system provided inside existing and operational water lines. The impellers are driven by existing water flow, gravity, and pressure points throughout pipeline networks that provide water to municipalities and other facilities. The power generated by the water through the spinning rotation of this impeller system will function in any system used to pump 500 to 10,000 plus gallons of water per minute throughout existing water lines. This new impeller system simultaneously captures and releases the water flow in route to its intended destination. The spinning rotation of the impellers are connected to generators that produce electricity. The disclosure describes the device and provides examples of implementation in new and/or existing water systems.

This disclosure includes a system that captures and transfers untapped energy within existing and operational pipeline networks in use on a daily basis. These pipeline networks are in use twenty-four hours a day, seven days a week and three-hundred and sixty-five days a year. This system involves very few moving parts. Already in existing municipalities and pipelines are billions of gallons of water in place and used daily to provide water for many purposes, such as drinking water, irrigation and sewage systems. Existing locations for this new system include water utilities, waste water facilities, water storage facilities, municipalities, factories, universities, water parks, etc. Other prime locations include desalinization plants, offshore platforms, military facilities, petrochemical plants or other industries that use large volumes of water or fluids on a daily basis. This new system works in unison with all existing water or fluid systems, including other liquid transfer systems, to generate electricity.

The system includes a cylindrical helical shaped device with multiple angled blades attached to a shaft, centered, and connected within a tubular arrangement. The shaft may also be spiraled. The blades are curved and connected around the axis of the shaft to evenly distribute the water flow throughout the rotation cycle. The water flows through a cross section of angled blades, centered, curved and positioned for maximum surface contact within the system. All additional interior surfaces within the system may be curved and spiraled. All surfaces, within the entire system simultaneously capture and release this same flow of water and are provided to also maximize the original intended flow of the water to its original destination. The spiraling and spinning rotation of these components are connected to one another, adding faster rotation and maximizing torque to the shaft. The shaft is connected to a generator that produces electricity. This system is one component installed within an existing and operational water or fluid line. One section of the existing water line is removed and replaced by the new impeller system, which has been chambered inside a fitting. One or more additional pipes may be installed around the fitting for maintenance purposes and for interrupted flow to the existing and operational system. If requested, any additional pipes will be provided for minimal friction loss.

Loss of pressure and volume in the existing water line is limited by increasing the interior mass inside the new fitting. The increased mass of the new impeller system is offset by the increased mass of the impeller inside the fitting. This keeps the original flow of water the same as it enters and exits the fitting. The pressure and volume of the existing water flow is only redirected through the impeller system and fitting. Both pressure and volume remain the same. It is also important to note that the shape and pattern of the water that exits this new system, has been provided to exit in a momentary helical shape that quickly dissipates to limit any additional turbulence. The existing water pumps installed up-stream, combined with gravity and existing pressure points within operational networks, provide more than enough power to generate electricity and to operate this system.

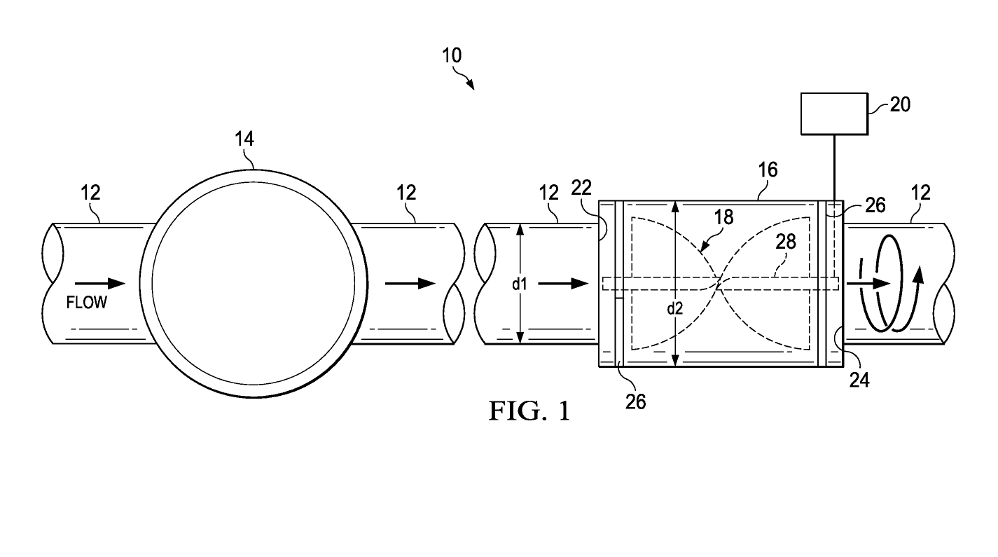

A system 10 according to the embodiment of FIG. 1, includes a fluid conduit 12 having an energy source such as a pump 14 for moving fluid through the conduit 12, a cylindrical chamber 16 mounted in the conduit 12 and an impeller 18 rotatably and coaxially mounted in the cylindrical chamber 16. Energy may be provided to a generator 20 by the rotating impeller 18 to generate electricity.

The pump 14 when operating at a constant speed, will move fluid through a constant diameter conduit 12 at a constant pressure and velocity. Thus, conduit 12 has a constant first diameter designated d-1. The chamber 16 includes a second diameter designated d-2, which is larger or greater than diameter d-1. An inlet 22 and an outlet 24 of the chamber 16 each have the first diameter d-1. Thus, fluid entering the chamber 16 will realize a drop in pressure and velocity.

The impeller 18 is supported at opposite ends, adjacent the inlet 22 and outlet 24, respectively, by a pair of bearing mounts 26 which support a shaft 28 of the impeller 18 thus permitting free rotation of the impeller 18. Shaft 28 is coaxially mounted in cylinder 16 and is coaxial with conduit 12.

Although pressure of a fluid moving through conduit 12 along a laminar flow path, drops in pressure and velocity upon entering chamber 16, there is sufficient velocity to rotate or spin the impeller 18 and exit outlet 24 in a helical flow path. The helical path will eventually return to a laminar flow path at essentially the same velocity and pressure as the fluid was flowing prior to entry of the chamber 16. An advantage is that there is no back-up pressure in the conduit 12 which is realized by the pump 14 so as to cause the pump 14 to operate inefficiently, thus causing loss of any electrical generating advantage provided by the impeller 18.

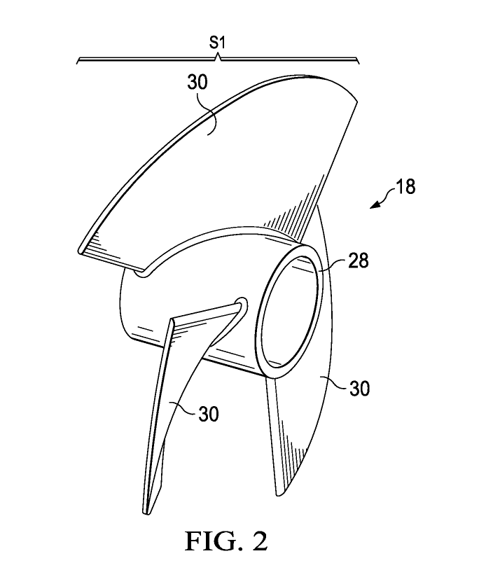

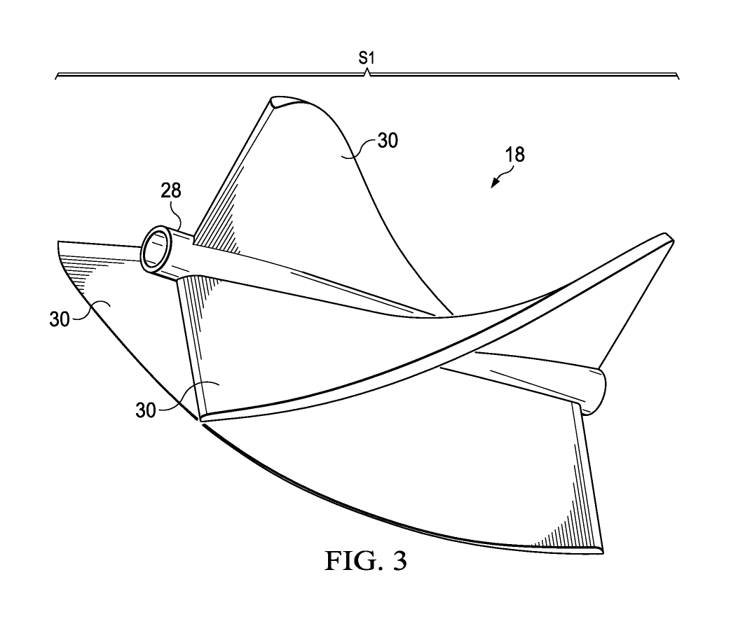

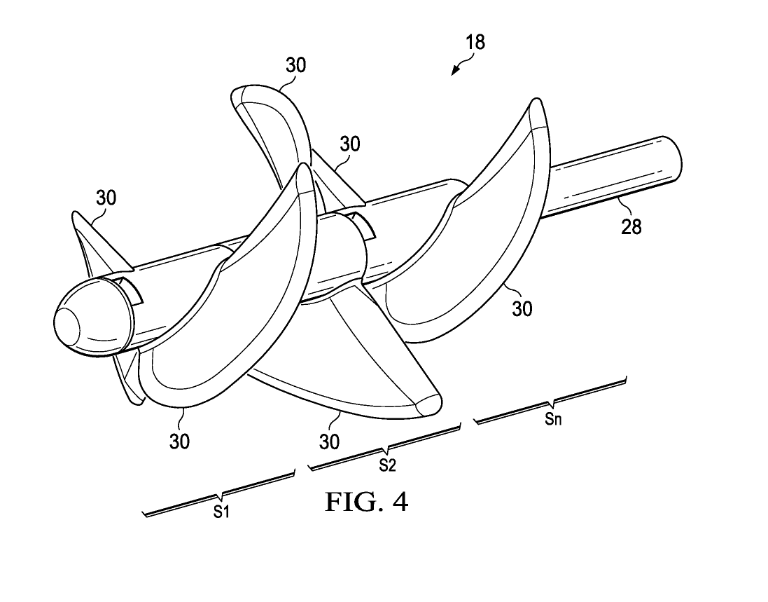

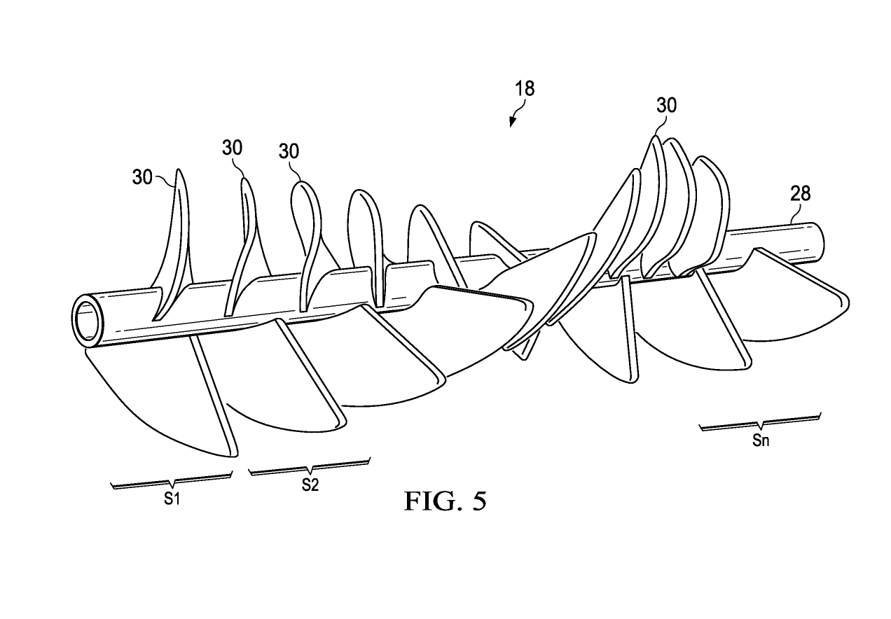

FIGS. 2 and 3 include shaft 28 and a set 51 of blades, comprising a plurality of blades 30. FIGS. 4 and 5 include the shaft 28 and multiple sets of blades S1, S2 . . . Sn, comprising a plurality of blades 30. In FIGS. 4 and 5, each set of blades 30 is offset from each other set of blades 30.

The foregoing has described an impeller device and system within a fluid conduit. The impeller is rotated by fluid flowing through the conduit sufficient to generate electricity.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A system comprising:
a fluid conduit having a first diameter;
a cylindrical chamber coaxially mounted in the fluid conduit, the chamber having a second diameter greater than the first diameter;
an inlet at a first end of the chamber, the inlet having the first diameter and being connected to the fluid conduit;
an outlet at a second end of the chamber opposite the first end, the outlet having the first diameter and being connected to the fluid conduit; and
an impeller having a shaft coaxially and rotatably mounted in the chamber, the impeller having a plurality of impeller blades mounted on the shaft, rotation of the blades defining a diameter greater than the first diameter and less than the second diameter.

2. The system of claim 1 wherein the impeller includes a single set of multiple blades.

3. The system of claim 1 wherein the impeller includes a plurality of adjacent sets of multiple blades.

4. The system of claim 3 wherein each set of multiple blades is offset from each adjacent set of multiple blades.

5. The system of claim 1, further comprising:
pump means for moving fluid through the conduit and the chamber.

6. The system of claim 1, further comprising:
a generator connected to receive energy from the rotatable impe

7. A system comprising:
a fluid conduit having a first diameter;
a cylindrical chamber coaxially mounted in the fluid conduit, the chamber having a second diameter greater than the first diameter;
an inlet at a first end of the chamber, the inlet having the first diameter and being connected to the fluid conduit;
an outlet at a second end of the chamber opposite the first end, the outlet having the first diameter and being connected to the fluid conduit;
pump means for moving fluid through the conduit and the chamber; and
an impeller having a shaft coaxially and rotatably mounted in the chamber, the impeller having a plurality of impeller blades mounted on the shaft, rotation of the blades defining a diameter greater than the first diameter and less than the second diameter.

8. The system of claim 7 wherein the impeller includes a single set of multiple blades.

9. The system of claim 7 wherein the impeller includes a plurality of adjacent sets of multiple blades.

10. The system of claim 9 wherein each set of multiple blades is offset from each adjacent set of multiple blades.

11. The system of claim 7, further comprising:
a generator connected to receive energy from the rotatable impeller.

12. A method comprising:
providing a fluid conduit having a first diameter;
coaxially mounting a cylindrical chamber in the fluid conduit, the chamber having a second diameter greater than the first diameter;
providing an inlet at a first end of the chamber, the inlet having the first diameter and being connected to the fluid conduit;
providing an outlet at a second end of the chamber opposite the first end, the outlet having the first diameter and being connected to the fluid conduit;
coaxially and rotatably mounting an impeller, having a shaft, in the chamber, the impeller having a plurality of impeller blades mounted on the shaft, rotation of the blades defining a diameter greater than the first diameter and less than the second diameter; and
connecting a generator to receive energy from the rotatable impeller.

13. The method of claim 12 wherein the impeller includes a single set of multiple blades.

14. The method of claim 12 wherein the impeller includes a plurality of adjacent sets of multiple blades.

15. The method of claim 14 wherein each set of multiple blades is offset from each adjacent set of multiple blades.

16. The method of claim 12, further comprising;
providing pump means for moving fluid through the conduit and the chamber.

17. The method of claim 12 wherein, in response to fluid flowing through the conduit and the chamber, the impeller is rotated sufficiently to provide energy to the generator for generating electricity.

18. The method of claim 16, further comprising:
pumping fluid through the conduit and the chamber sufficiently to rotate the impeller, whereby the impeller provides sufficient energy to the generator for generating electricity.
